(19) United States
(12) Patent Application Publication
(10) Pub. No.: US 2019/0089922 A1
(43) Pub. Date: Mar. 21, 2019

(54) MOBILE DISPLAY DEVICE, IMAGE SUPPLY DEVICE, DISPLAY SYSTEM, AND PROGRAM

(71) Applicant: SHARP KABUSHIKI KAISHA, Sakai City (JP)

(72) Inventor: TOSHIO HATA, Sakai City (JP)

(21) Appl. No.: 16/116,784

(22) Filed: Aug. 29, 2018

(30) Foreign Application Priority Data
Sep. 20, 2017 (JP) 2017-180590

(51) Int. Cl. H04N 5/44; H04N 7/18; G01S 19/14

(52) U.S. Cl. CPC H04N 5/4403; H04N 7/181; H04N 2005/4423; H04N 2005/4408; G01S 19/14

(57) ABSTRACT

A mobile display device includes a captured image acquisition unit that acquires captured images captured by an image capturing device attached to each of a plurality of moving bodies, a selection unit that refers to limitation information to select a captured image that is to be presented from the captured images acquired by the captured image acquisition unit, and a display unit that displays the captured image selected by the selection unit.

### BACKGROUND

### 1. Field

The present disclosure relates to a mobile display device, an image supply device, a display system, and a program.

### 2. Description of the Related Art

Conventionally, an audience has viewed a TV (flat-panel television such as a liquid crystal television, for example) provided inside a room in the inside or the outside of an entertainment hall or a large-sized display device installed in a ticket office outside the hall or a public space to grasp the site state with realistic sensations enhanced, in many cases.

For example, Japanese Unexamined Patent Application Publication No. 2015-198443 (laid open on Nov. 9, 2015) discloses that a live video captured by a live camera is displayed in superposition on a ticket owned by an individual. According to Japanese Unexamined Patent Application Publication No. 2015-198443, when a ticket of a musical concert is imaged with a smartphone camera, a video capturing a dressing room scene of a performer of the concert at the current time is displayed in superposition on the ticket, image, for example.

However, in the case of the technique disclosed in Japanese Unexamined Patent Application Publication No. 2015-198443, there is room for further improvement in the aspect of enhancing a sense of unity between a user and a performer.

### SUMMARY

According to an aspect of the present disclosure, there is provided a mobile display device including a captured image acquisition unit that acquires captured images captured by an image capturing device attached to each of a plurality of moving bodies, a selection unit that refers to Limitation information to select a captured image that is to be presented from the captured images acquired by the captured image acquisition unit, and a display unit that displays the captured image selected by the selection unit.

### BRIEF DESCRIPTION OF THE DRAWINGS

FIG. 1 is a block diagram illustrating a configuration of a display system according to a first embodiment of the present disclosure;

FIG. 2 is a block diagram illustrating a configuration of a variation of the display system according to the first embodiment of the present disclosure;

FIG. 3 is a block diagram illustrating a configuration of a display system according to a second embodiment of the present disclosure;

FIG. 4 is a block diagram illustrating a configuration of a variation of the display system according to the second embodiment of the present disclosure;

FIG. 5 is a schematic diagram explaining a configuration for transmitting and receiving information in a display system according to an embodiment of the present disclosure;

FIG. 6 is a diagram illustrating a display screen of a mobile display device according to an embodiment of the present disclosure;

FIG. 7 is a schematic diagram illustrating a case where an audience in the display system according to the first embodiment of the present disclosure is a coach; and

FIG. 8 is a schematic diagram illustrating a configuration of a variation of the display system according to the first embodiment of the present disclosure.

### DESCRIPTION OF THE EMBODIMENTS

### First Embodiment

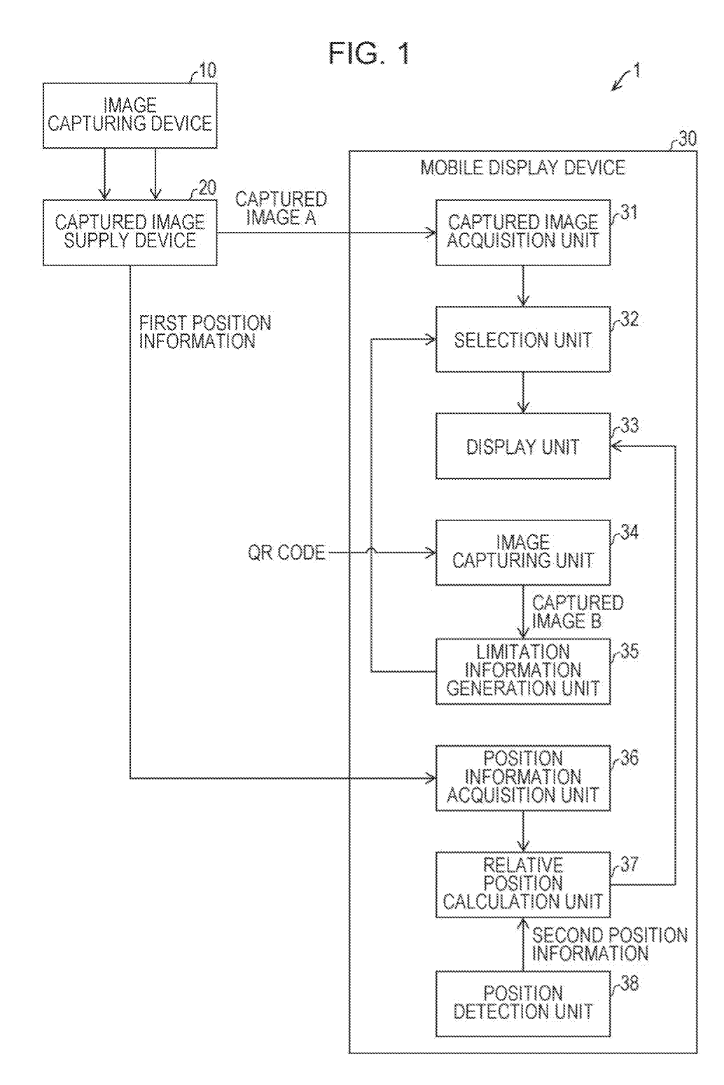

The present embodiment will be described below with reference to FIG. 1.

### <Configuration of Display System>

FIG. 1 is a block diagram illustrating a configuration of a display system 1 according to the present embodiment. As illustrated in FIG. 1, the display system 1 includes an image capturing device 10, a captured image supply device 20, and a mobile display device 30.

The image capturing device 10 is attached to each of a plurality of moving bodies (a person or an animal, and in the present embodiment, a performer, a player, or a racehorse, for example). A captured image A (a still image or a video) viewed from the eyes of each of the plurality of moving bodies is captured. Although the image capturing device 10 is a small-sized camera for a visible light region, for example, the present embodiment is not limited thereto. The image capturing device 10 supplies the captured image A that has been captured to the captured image supply device 20.

Furthermore, the image capturing, device 10 includes a position detection unit that detects the position of the image capturing device 10, which is not illustrated, and supplies position information (hereinafter, referred to as first position information) of the image capturing device 10 that has been thus detected to the captured image supply device 20. Furthermore, although the above-described position detection unit is a global positioning system (GPS) receiver, for example, the present embodiment is not limited thereto. For example, the position detection unit is desirably a differential global positioning system (DGPS) receiver for further improving the accuracy thereof, and is further desirably an indoor messaging system (IMES)-based GPS receiver for enabling acquisition of indoor position information.

The captured image supply device 20 receives the captured image A and the first position information from the image capturing device 10. The captured image supply device 20 then supplies the captured image A and the first position information to each of a captured image acquisition unit 31 and a position information acquisition unit 36 of the mobile display device 30, which will be described below.

As illustrated in FIG. 1, the mobile display device 30 includes the captured image acquisition unit 31, a selection unit 32, a display unit 33, an image capturing unit 34, a limitation information generation unit 35, the position information acquisition unit 36, a relative position calculation unit 37, and a position detection unit 38.

Furthermore, the mobile display device 30 is formed of a display with high pixel density and desirably includes an organic EL micro display, a liquid crystal display, a micro LED, a GaN on Si LED, a micro nanowire LED, or a nanowire LED, for example.

The captured image acquisition unit 31 acquires the captured image A and supplies the acquired captured image A to the selection unit 32.

The selection unit 32 refers to limitation information to select a captured image that is to be presented from the captured images acquired by the captured image acquisition unit 31. The limitation information here is information generated by the limitation information generation unit 35 to be referred to when a captured image that is to be presented is selected from the captured images.

The display unit 33 displays the captured image selected by the selection unit 32. The display unit 33 may be a small-sized display panel, for example. In the present embodiment, the display unit 33 is a small-sized display device attached to goggles or glasses of an audience, for example. However, the present embodiment is not limited thereto.

Furthermore, the captured image A may be a still image but is desirably a video. Specifically, information captured from the eyes of a moving body is transmitted to the captured image acquisition unit 31 via the image capturing device 10. This configuration enables to provide realistic sensations, feelings of tension, uplifting feelings, feelings of further expectations, and the like to an audience.

Furthermore, the mobile display device 30 desirably further includes the image capturing unit 34 and the limitation information generation unit 35. The image capturing unit 34 images a QR code® related to the moving body, for example. Although the image capturing unit 34 may include the same configuration as that of the image capturing device 10, the present embodiment is not limited thereto.

Furthermore, when the moving body is a person as a performer, for example, the QR code is a barcode printed on a ticket for an event in which the performer appears, or the like. As another example, when the moving body is an animal and a racehorse, a barcode printed on a betting ticket or the like con be cited.

As still another example, when the moving body is a person as a player, a barcode printed on a ticket for a competition or a game in which the player participates or the like can be cited. For the game here, American football, soccer, baseball, or the like can be cited.

The limitation information generation unit 35 refers to a captured image B captured by the image capturing unit 34 to generate the limitation information.

As described above, the limitation information is information generated by the limitation information generation unit 35 to be referred to when a captured image that is to be presented is selected from the captured images. More specifically, the limitation information is information that sets a limit such that only a captured image of a moving body that is associated with the QR code is selectable, for example. The limitation information may be set as appropriate by an organizer of the above-described event or the like, for example.

The mobile display device 30 desirably further includes the position information acquisition unit 36 that acquires the position information (first position information) of a moving body attached with the image capturing device 10 that has captured the captured image A displayed by the display unit 33.

When the position information acquisition unit 36 is configured to provide the acquired position information to an audience, the audience may grasp all the time the current position of a moving body that is moving and thus easily follow the moving body.

The mobile display device 30 desirably further includes the relative position calculation unit 37 that refers to the first position information that is the position information acquired by the position information acquisition unit 36 and second position information that is the position information of the mobile display device 30 and is detected by the position detection unit 38 included in the mobile display device 30, to calculate a relative position between the position indicated by the first position info rotation and the position indicated by the second position information. The relative position information calculated by the relative position calculation unit 37 is supplied to the display unit 33 and displayed to an audience.

With the above-described configuration, for example, an audience who views a concert in an entertainment hall or a game in a stadium may share realistic sensations being united with a performer through the mobile display device 30 even with a sense of distance from the performer. That is to say, the audience may feel as if he or she participates in the concert or the game and visually accept further realistic sensations, feelings of expectation, and the like. As described above, according to the configuration described in the present embodiment, a world that may be referred to as transferred reality (possessed reality) may be realized.

Furthermore, when the performer is a sports player, the image capturing device 10 captures the captured image A viewed from the eyes of the sports player and supplies the captured image A thus captured to the captured image supply device 20 and also supplies the first position information to the captured image supply device 20. Thereafter, the captured image supply device 20 supplies the captured image A and the first position information to the captured image acquisition unit 31 and the position information acquisition unit 36 of the mobile display device 30, which will be described below, respectively. The mobile display device 30 performs various types of processing with respect to the acquired captured image A and first position information, thereby displaying the current status of the sports player in the game (for example, vehicle speed, number of laps, current ranking, and the like) to an audience using the display unit 33. Furthermore, the image capturing device 10 may further include a measuring instrument that measures current health information (for example, blood pressure, pulse count, heart rate, and the like) of the sports player and thereby transmit the above-described health information to the mobile display device 30, so that the mobile display device 30 displays the health information in real time. With this configuration, the mobile display device 30 may contribute to help an audience to grasp the current situation and help a manager to manage health conditions of a sports player, for example. It is to be noted that the measuring instrument that measures the health conditions described above may be included in the display system 1 separately from the image capturing device 10. Furthermore, a presentation device that presents the health information described above may be included in the display system 1 separately from the mobile display device 30. These configurations are included in the scope of the disclosure described herein. Possibly, a sports player does not have to wear the image capturing device 10.

With respect to the above-described points, more specific examples will be described below. The mobile display device 30 displays a sports player or a racehorse. Furthermore, the mobile display device 30 displays the ranking, the speed, the distance, the number of laps, and the like of the sports player or the racehorse at the current time using characters or the like, at the same time displaying the video.

The information indicating, these ranking, speed, distance, number of laps, and the like is generated in the captured image supply device 20, for example, by referring to

(1) the position information acquired from the image capturing device. 10 attached to a target sports player or a target racehorse, and

(2) the position information acquired from the image capturing device 10 attached to another target sports player or another target racehorse. The generated information indicating the ranking, the speed, the distance, the relative distance, the number of laps, and the like is supplied to the mobile display device 30.

When an audience S1 is present in the stadium, the value of the relative position (relative distance) on the display unit 33 of the mobile display device 30 is decreased. In other words, it is indicated that a player E1 selected using the selection unit 32 is coming closer to the audience S1. At this time, the audience S1 may have or obtain more feelings of expectation and feelings of sharing.

An audience herein is a spectator who watches in a racing circuit, a cycling stadium, an athletics stadium, a soccer stadium, an indoor gymnasium, a motorboat racing field, an auto race field, or the like. A player herein is a player who plays in a stadium.

Furthermore, as described later with reference to FIG. 7, when a relation between the sports player and the audience or the manager is changed to a relation between a player coached by a coach and the coach, the above-described health information (for example, blood pressure, pulse, count, heart rate, and the like) may be grasped on a daily basis during a practice or a training, rather than a game. This enables to adjust health conditions of a sports player to the best conditions for a tournament or a game in which the sports player participates.

The health conditions such as the blood pressure, pulse count, heart rate, and the like of a sports player or a racehorse also are measured with the above-described measuring instrument and the measured data is provided to the mobile display device 30. The mobile display device 30 displays the health conditions using characters or the like, at the same time displaying the video. This is also effective in management of health conditions of a sports player or a racehorse in a medical point of view. It is to be noted that as the measuring instrument, an attachable, light weight, and thin-film type, what is called, a wearable type of measuring instrument may be used. Possibly, an attachable measuring instrument may be included in a uniform or a sportswear of a player, or a measuring instrument may be embedded in the inside of a uniform or a sportswear, or incorporated into a uniform or a sportswear.

It is to be noted that an information communication method in the present embodiment with respect to the captured image A and the first position information, for example, may be implemented by a communication network or the like. The communication network may include a telephone network. Furthermore, the communication network may include both wired and wireless networks. As the communication network, for example, the Internet may be used instead of a telephone network.

Furthermore, in the above-described examples, public competitions and the like have been specifically cited as examples. However, the present embodiment is not limited thereto, and may be related to a motor race, a cycling competition (a track race, a road race, or the like), a running competition (a track race, a marathon tournament, or the like), a horseracing, a race of motor boats or yachts, a military affair, an Olympic game (for example, the Tokyo Olympic in 2020), a world championship (what is called sports such as track and field, swimming, or volley ball) or the like. When the present embodiment is adapted into these, the image capturing device 10 may be attached to a moving body such as a player, an animal, or an automobile to be a target, enabling to realize transferred reality (possessed reality) making one feel as if transferring to such a moving body.

### <Variation of First Embodiment>

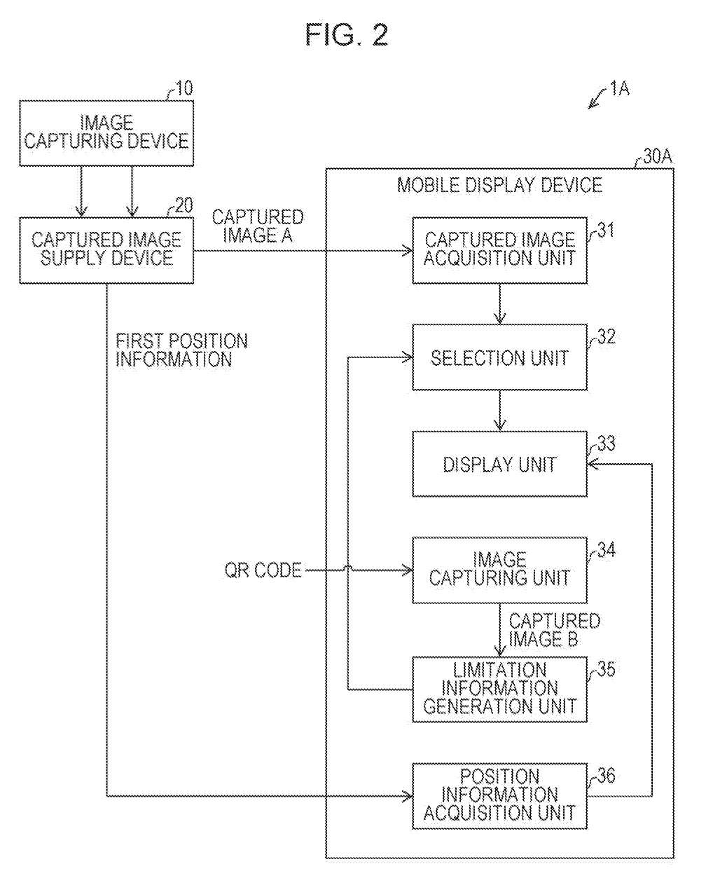

In the examples described above, the mobile display device 30 includes the relative position calculation unit 37. However, in the present embodiment, the relative position calculation unit 37 is not imperative. For example, when an audience is present outside an entertainment hall or a stadium, the relative position information may not be calculated. An example of such a configuration will be described with reference to FIG. 2.

FIG. 2 is a block diagram illustrating a configuration of a display system 1A according to the present variation. When compared with FIG. 1, in a mobile display device 30A illustrated in FIG. 2, the position detection unit 38 and the relative position calculation unit 37 are omitted, compared with the mobile display device 30 illustrated in FIG. 1. Furthermore, the first position information is supplied to the display unit 33 via the position information acquisition unit 36. The display unit 33 may display information based on the first position information.

Other components in the configuration are the same as in the display system 1, and thus the description thereof will be omitted.

The same effects as in the above-described first embodiment may be achieved with the configuration of the present variation.

### Second Embodiment

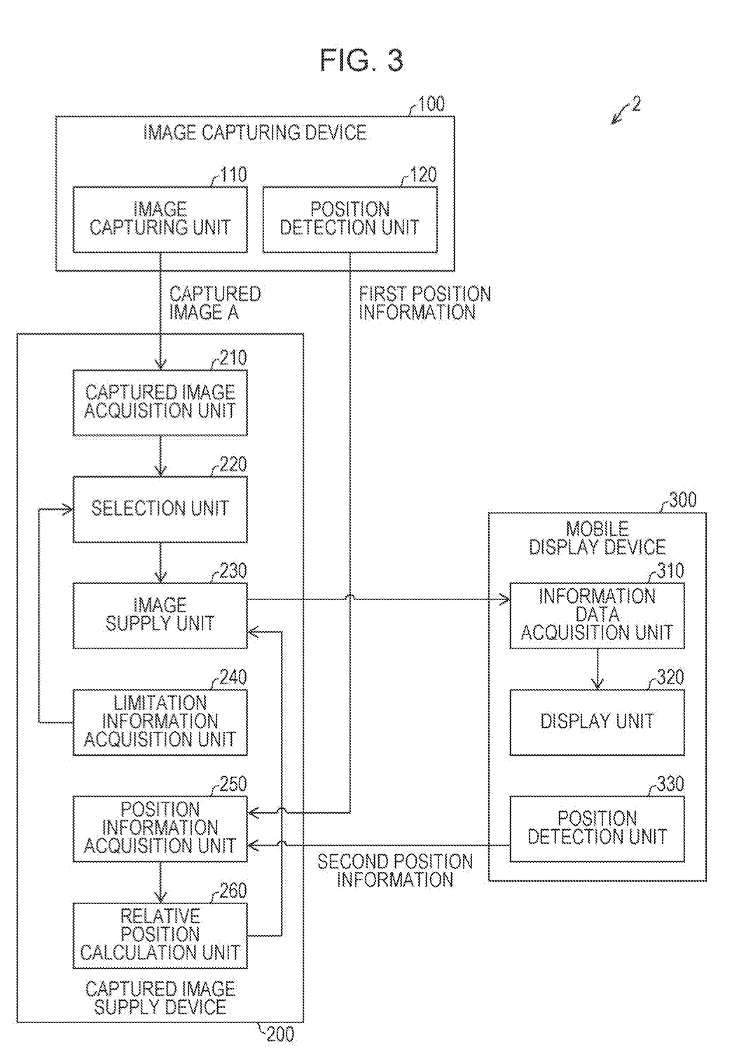

The present embodiment will be described below with reference to FIG. 3.

In the first embodiment, processing is performed by referring to the limitation information in the mobile display device 30. However, the present disclosure is not limited thereto, and processing may be performed by referring to the limitation information in an image supply device (server), for example.

### <Configuration of Display System>

FIG. 3 is a block diagram illustrating a configuration of a display system 2 according to the present embodiment. As illustrated in FIG. 3, the display system 2 includes an image capturing device 100, a captured image supply device 200, and a mobile display device 300.

The image capturing device 100 includes an image capturing unit 110 and a position detection unit 120. The image capturing device 100 is attached to each of a plurality of moving bodies (a person or an animal, and in the present embodiment, a performer or a racehorse, for example). A captured image A (a still image or a video) being information viewed from the eyes of each of the plurality of moving bodies is captured by the image capturing unit 110. Although the image capturing device 100 is a small-sized camera for a visible light region, for example, similarly to the image capturing device 10 in the first embodiment, the present embodiment is not limited thereto. The image capturing device 100 supplies the captured image A that has been captured to a captured image acquisition unit 210 in the captured image supply device 200 described below.

Furthermore, the image capturing device 100 includes a position detection unit 120 that detects the position of the image capturing device 100 and supplies position information (hereinafter, referred to as first position information) of the image capturing device 100 that has been thus detected to a position information acquisition unit 250 in the captured image supply device 200 described below. Furthermore, similarly to the position detection unit in the above-described first embodiment, which is not illustrated, for example, the position detection unit 120 is global positioning system (GPS) receiver. However, the present embodiment is not limited thereto. For example, the position detection unit 120 is desirably a differential global positioning system (DGPS) receiver for further improving the accuracy thereof, and is further desirably an indoor messaging system (IMES)-based GPS receiver for enabling acquisition of indoor position information.

The captured image acquisition unit 210 and the position information acquisition unit 250 in the captured image supply device 200 receives the captured image A and the first position information, respectively, from the image capturing device 100.

A configuration of the captured image supply device 200 will be described below.

As illustrated in FIG. 3, the captured image supply device 200 includes the captured image acquisition unit 210, a selection unit 220, an image supply unit 230, a limitation information acquisition unit 240, the position information acquisition unit 250, and a relative position calculation unit 260.

The captured image acquisition unit 210 acquires the captured image A and supplies the acquired captured image A to the selection unit 220.

The selection unit 220 refers to the limitation information to select a captured image that is to be presented from the captured images acquired by the captured image acquisition unit 210. The limitation information here is information acquired by the limitation information acquisition unit 240 to be referred to when a captured image that is to be presented is selected from the captured images.

It is to be noted that the limitation information acquisition unit 240 may acquire the limitation information from an external server or acquire the limitation information generated by a limitation information generation unit included in the captured image supply device 200.

Furthermore, the limitation information acquisition unit 240 may acquire the limitation information generated by referring to information ouch as a QR code captured by an image capturing unit included in the mobile display device 300. In this case, the generation of the limitation information may be performed by a limitation information generation unit included in the mobile display device 300 or performed by the limitation information generation unit included in the captured image supply device 200.

The image supply unit 230 supplies the captured image selected by the selection unit 220 to an information data acquisition unit 310 in the mobile display device 300 described below.

Furthermore, the captured image A may be a still image but is desirably a video. Specifically, information viewed from the eyes of a moving body is transmitted to the captured image acquisition unit 210 via the image capturing device 100. This configuration enables to provide realistic sensations, feelings of tension, uplifting feelings, feelings of further expectations, and the like to an audience.

Furthermore, the captured image supply device 200 desirably includes the limitation information acquisition unit 240 that acquires the limitation information. For example, the mobile display device 300 may include an image capturing unit, and similarly to the first embodiment, the captured image supply device 200 may refer to the information captured by the image capturing unit to generate the limitation information, so that the limitation information acquisition unit 240 acquires the generated limitation information.

Furthermore, the captured imago supply device 200 desirably further include the position information acquisition unit 250 that acquires the position information (first position information) of a moving body attached with the image capturing device 100 that has captured the captured image selected by the selection unit 220.

When the captured image supply device 200 provides the position information acquired by the position information acquisition unit 250 to the audience, the audience may grasp all the time the current position of a moving body that is moving and thus easily follow the moving body.

Furthermore, the captured image supply device 200 desirably further includes the relative position calculation unit 260 that refers to the first position information that is the position information acquired by the position information acquisition unit 250 for a position where the position detection unit 120 has been detected and the second position information that is the position information of the mobile display device 300 for a position where a position detection unit 330 in the mobile display device 300 described below has been detected, to calculate a relative position between the position indicated by the first position information and the position indicated by the second position information.

The relative position information calculated by the relative position calculation unit 260 is supplied to the image supply unit 230.

Thereafter, the captured image to be displayed and the relative position information that have been received by the imago supply unit 230 are supplied to the information data acquisition unit 310 in the mobile display device 300 described below.

As illustrated in FIG. 3, the mobile display device 300 includes the information data acquisition unit 310, a display unit 320, and the position detection unit 330.

As described above, the information data acquisition unit 310 acquires the captured image to be displayed and the relative position information from the captured image supply device 200.

The display unit 320 converts the information data acquired by the information data acquisition unit 310 into data displayable on a display screen and uses the display screen or the like to display the converted information data. The display unit 320 may be a small-sized panel, for example. In the present embodiment, the display unit 320 is a small-sized display device attached to goggles or glasses of an audience, for example. However, the present embodiment is not limited thereto.

The same effects as in the above-described first embodiment may be achieved with the configuration of the present embodiment.

### <Variation of Second Embodiment>

In the above-described second embodiment, a configuration in which a captured image supply device includes a position information acquisition unit and a relative position calculation unit has been described. However, as a variation of the second embodiment, a mobile display device may include a position information acquisition unit and a relative position calculation unit.

Furthermore, a component in this variation that is the same as that in the second embodiment will be denoted with the same reference numeral, and the description thereof will be omitted.

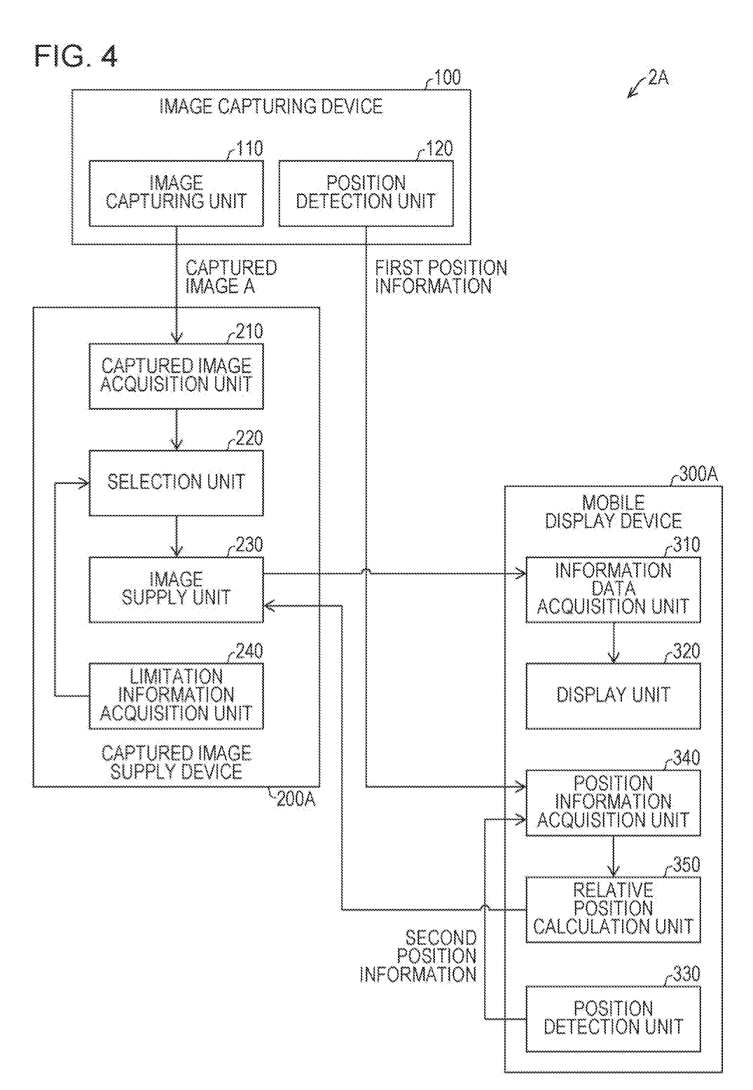

The present variation will be described below with reference to FIG. 4.

FIG. 4 is a block diagram illustrating a configuration of a display system 2A according to the present variation.

As illustrated in FIG. 4, when compared with the second embodiment, as described above, a captured image supply device 200A does not include a position information acquisition unit or a relative position calculation unit, and the mobile display device 300A includes a position information acquisition unit 340 and a relative position calculation unit 350, as a feature of the present variation.

A difference with the second embodiment will be focused on in the description below.

The first position information for a position where the position detection unit 120 in the image capturing device 100 has been detected is supplied to the position information acquisition unit 340 in the mobile display device 300A. The second position information for a position where the position detection unit 330 has been detected in the mobile display device 300A is also supplied to the position information acquisition unit 340. Thereafter, the position information acquisition unit 340 supplies the acquired pieces of position information to the relative position calculation unit 350. The relative position calculation unit 350 refers to the first position information and the second position information to calculate a relative position between the position indicated by the first position information and the position indicated by the second position information. The relative position information calculated by the relative position calculation unit 350 is then supplied to the image supply unit 230 in the captured image supply device 200A. Other components in the configuration are the same as in the second embodiment, and thus the description thereof will be omitted.

The same effects as in the above-described first and second embodiments may be achieved with the configuration of the present variation.

### <Configuration for Transmitting and Receiving Information in Display System>

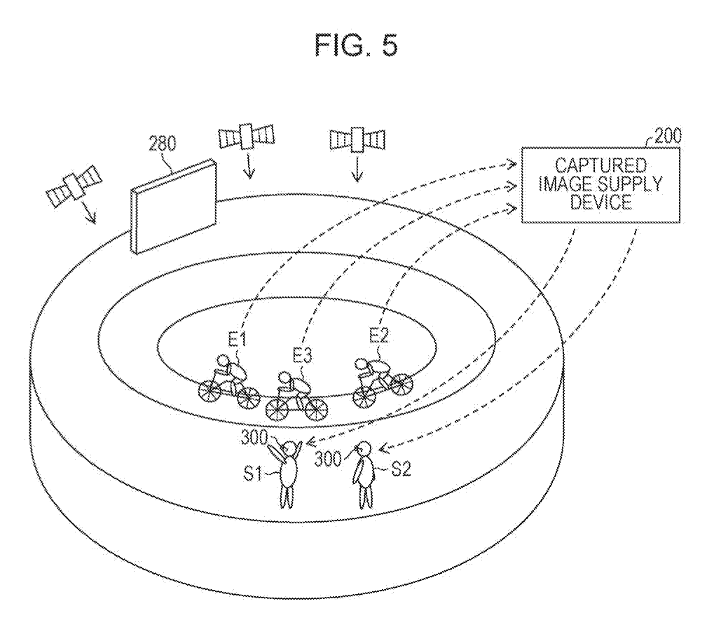

A configuration for transmitting and receiving information in a display system according to the first and second embodiments and the variations thereof will be described below with reference to FIG. 5. FIG. 5 is a schematic diagram explaining a configuration for transmitting and receiving information in a display system according to the present disclosure.

FIG. 5 illustrates one stadium, one large-sized display device 280 installed in the stadium, three GPS satellites (GPS transmitters), three performers (for example, cycle racers) E1, E2, and E3, audiences S1 and S2 who each have a mobile display device 300, and one captured image supply device (information transmission device), 200, for example.

At this point, an image capturing device 100 which is not illustrated is attached to each of three performers E1, E2, and E3. A captured image (still image or a video) being information viewed from the eyes of the performers E1, E2, and E3 may be supplied in real time to the mobile display devices 300 via the captured image supply device 200.

The selection unit 220 in the captured image supply device 200 refers to the limitation information to select a captured image that is to be presented from the captured images acquired by the captured image acquisition unit 210 and supplies the selected captured image to the mobile display device 300 via the image supply unit 230.

The mobile display device 300 displays the supplied captured image on the display unit 320, and the audiences S1 and S2 who have the mobile display devices 300 may view this captured image.

Furthermore, with the limitation information configured as appropriate, each of the audiences S1 and S2 may view only the captured image by the image capturing device 100 attached to a desired performer out of the performers E1, E2, and E3 or view the captured images from all the performers while switching the captured images.

### <Display Content in Display Screen>

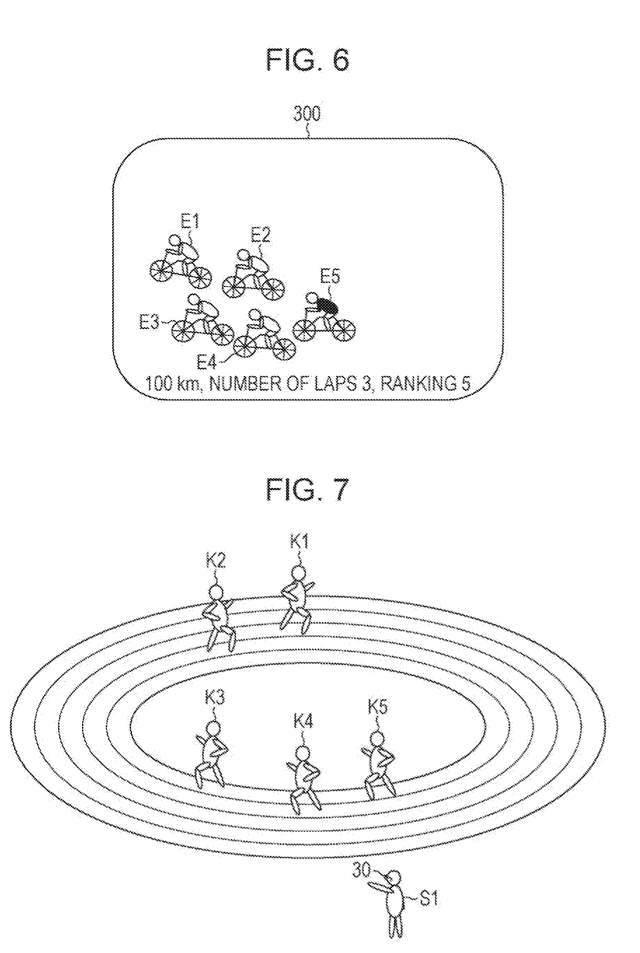

FIG. 6 is a diagram illustrating the display screen of the mobile display device 30, 30A, 300, or 300A according to the first or second embodiment, or the variation example thereof. As illustrated in FIG. 6, the display unit 33 or 320 of the mobile display device 30, 30A, 300, or 300A displays speeds, numbers of laps, and the ranking of target player (E5 in FIG. 6) wearing the image capturing device 10 attached thereto, together with images presenting other players (E1 to E4 in FIG. 6) than the target player. This example describes a configuration in which the target player wearing the image capturing device 10 attached thereto is displayed in the display unit 33 or 320. However, the present embodiment is not limited thereto, and may employ a configuration in which the target player is not displayed in the display unit 33 or 320. Furthermore, the present embodiment may employ a configuration in which the target player wearing the image capturing device 10 attached thereto may be displayed so as to be distinguished from the other players than the target player. For example, the present embodiment may employ a configuration in which the target player wearing the image capturing device 10 attached thereto is displayed using a color or the degree of transparency different from those for the other players than the target player.

FIG. 7 is a schematic diagram illustrating a case where an audience in the display system according to the first or second embodiment or the variations thereof is a coach. In a relation between sports, players K1 to K5 and a coach S1 who coaches the sports players K1 to K5, health information (for example, blood pressure, pulse count, heart, rate, and the like) of the sports players K1 to K5 as well as playing performances may be grasped on a daily basis during a practice or a training. This enables the coach S1 to adjust health conditions of the sports players K1 to K5 to the best conditions for a tournament or a game in which the sports players K1 to K5 participate.

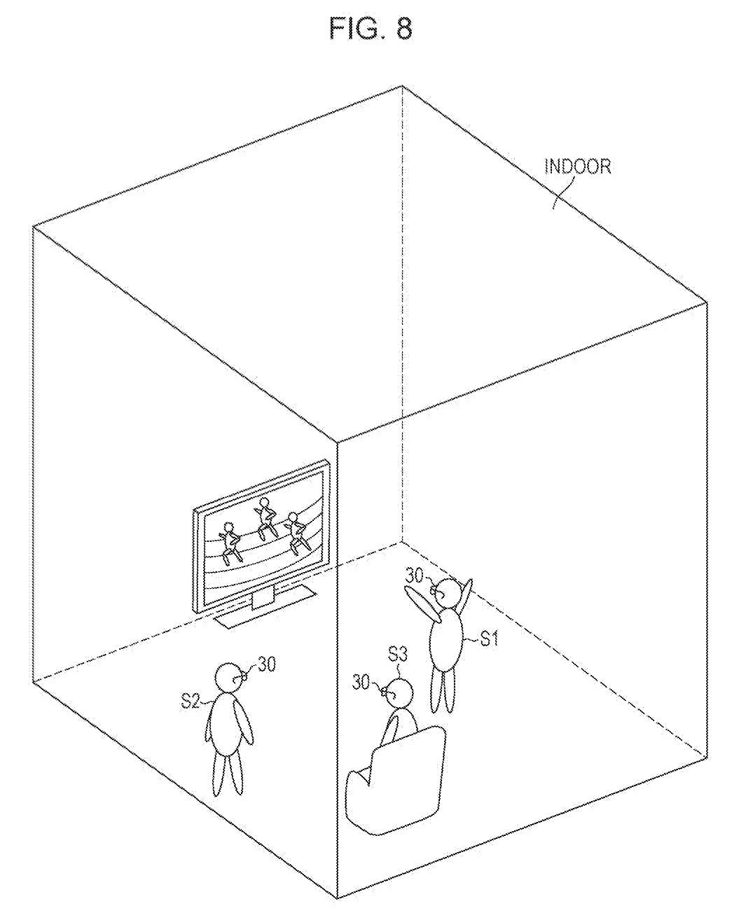

FIG. 8 is a schematic diagram illustrating a configuration of the display system according to the first and second embodiments and the variations thereof. In the example illustrated in FIG. 8, audiences S1 to S3 are present not in a stadium but indoor, in a building (for example, his or her home) other than the stadium. In this case, unlike a case where the audiences S1 to S3 are in the stadium, the relative position calculation unit 37 is not imperative. Under such an environment, the display system 1A described in the variation of the first embodiment is suitably applicable. In that case, the display unit 33 may simply display information based on the first position information, for example.

### Implementation Example Using Software

A control block of the mobile display device 30, the image capturing device 100, or the captured image supply device 200 (in particular, the captured image acquisition unit 31, the selection unit 32, the display unit 33, the relative position calculation unit 37, the information data acquisition unit 310, or the like) may be implemented by a logic circuit (hardware) formed on an integrated circuit (IC chip) or the like or may be implemented by software.

In the case of using software, the mobile display device 30 includes a computer that executes a command of a program being software implementing various functions. This computer includes at least one processor (control device) and at least one computer-readable storage medium storing therein the above-described program, for example. in the computer, the processor reads the program from the storage medium and executes the read program, whereby the present disclosure is implemented. As the processor, a central processing unit (CPU) may be used, for example. As the storage medium, a “non-transitory tangible medium”, for example, a read only memory (ROM) as well as a tape, a disc, a card, a semiconductor memory, a programmable logic circuit, or the like may be used. Furthermore, a random access memory (RAM) or the like, into which the program is loaded, may be further included. Furthermore, the program may be supplied to the computer via an optional transmission medium (communication network, a broadcast wave, or the like) that can transmit the program. It is to be noted that an aspect of the present disclosure may be implemented in a form of data signal embedded in a carrier wave, in which the program is embodied by electrical transmission.

A mobile display device (30) according to a first aspect of the present disclosure includes a captured imago acquisition unit (31) that acquires captured images captured by an image capturing device attached to each of a plurality of moving bodies, a selection unit (32) that refers to limitation information to select a captured image that is to be presented from the captured images acquired by the captured image acquisition unit (31), and a display unit (33) that displays the captured image selected by the selection unit (32).

According to the above-described configuration, an owner (audience) of the mobile display device (30) may view a captured image related to a performer displayed on the display unit (33), and even with a sense of distance from the performer, the audience may share realistic sensations being united with the performer through the mobile display device (30).

In the above-described first aspect, the mobile display device (30) according to a second aspect of the present disclosure may further include an image capturing unit (34) and a limitation information generation unit (35) that refers to a captured image captured by the image capturing unit (34) to generate the limitation information.

According to the above-described configuration, the mobile display device (30) may image a OR code or the like to generate the limitation information.

In the above-described first or second aspect, the mobile display device (30) according to a third aspect of the present disclosure may further include a position information acquisition unit (36) that acquires position information of a moving body attached with the image capturing device that has captured the captured image displayed by the display unit (33).

According to the above-described configuration, the position information of a moving body (a performer or an animal such as a racehorse) may be grasped all the time.

In the above-described third aspect, the mobile display device (30) according to a fourth aspect of the present disclosure may further include a relative position calculation unit (37) that refers to first position information that is the position information acquired by the position information acquisition unit (36) and second position information that is the position information indicating a position of the mobile display device (30) to calculate a relative position between the position indicated by the first position information and the position indicated by the second position information.

According to the above-described configuration, the relative position information of a moving body (a performer or an animal such as a racehorse) with respect to an audience may be grasped all the time.

As for the mobile display device (30) according to a fifth aspect of the present disclosure, in any one of the above-described first to fourth aspects, the moving body may be a person or an animal.

According to the above-described configuration, an audience may view from the eyes of the person or the animal.

An image supply device (200) according to a sixth aspect of the present disclosure includes a captured image acquisition unit (210) that acquires captured images captured by an image capturing device attached to each of a plurality of moving bodies, a selection unit (220) that refers to limitation information to select a captured image that is to be presented from the captured images acquired by the captured image acquisition unit (210), and an image supply unit (230) that supplies the captured image selected by the selection unit (220) to a mobile display device (300).

According to the above-described configuration, an owner (audience) of the mobile display device (300) may view a captured image related to a performer displayed on a display unit thereof, and even with a sense of distance from the performer, the audience may share realistic sensations being united with the performer through the mobile display device (300).

In the above-described sixth aspect, the image supply device (200) according to a seventh aspect of the present disclosure may further include a limitation information acquisition unit (240) that acquires the limitation information.

According to the above-described configuration, the image supply device (200) may image a QR code or the like to generate the limitation information.

In the above-described sixth or seventh aspect, the image supply device (200) according to an eighth aspect of the present disclosure may further include a position information acquisition unit (250) that acquires position information of a moving body attached with the image capturing device that has captured the captured image selected by the selection unit (220).

According to the above-described configuration, the position information of a moving body (a performer or an animal such as a racehorse) may be grasped all the time.

In the above-described eighth aspect, the image supply device (200) according to a ninth aspect of the present disclosure may further include a relative position calculation unit (260) that refers to first position: information that is the position information acquired by the position information acquisition unit (250) and second position information that is the position information indicating a position of the mobile display device (300) to calculate a relative position between the position indicated by the first position information and the position indicated by the second position information.

According to the above-described configuration, the relative position information of a moving body (a performer or an animal such as a racehorse) with respect to an audience may be grasped all the time.

As for the image supply device (200) according to a tenth aspect of the present disclosure, in any one of the above-described sixth to ninth aspects, the moving body may be a person or an animal.

According to the above-described configuration, an audience may view from the eyes of the person or the animal.

A display system (1, 2, or 2A) according to an aspect, of the present disclosure includes an image capturing device (10 or 100) attached to each of a plurality of moving bodies, an image supply device (20, 200, 200A), and a mobile display device (30, 300, or 300A). The image supply device (200 or 200A) includes a captured image acquisition unit (210) that acquires captured images captured by the image capturing device (100), a selection unit (220) that refers to limitation information to select a captured image that is to be presented from the captured images acquired by the captured image acquisition unit (210), and an image supply unit (230) that supplies the captured image selected by the selection unit (220) to the mobile display device (300 or 300A). The mobile display device (300 or 300A) includes a captured image acquisition unit (310) than acquires the captured image selected by the selection unit (220) and a display unit (320) that displays the captured image acquired by the captured image acquisition unit (310).

According to the above-described configuration, an owner (audience) of the mobile display device (300 or 300A) may view a captured image related to a performer displayed on the display unit (320), and even with a sense of distance from the performer, the audience may share realistic sensations being united with the performer through the mobile display device (300 or 300A).

The present disclosure contains subject matter related to that disclosed in Japanese Priority Patent Application JP 2017-180590 filed in the Japan Patent Office on Sep. 20, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A mobile display device comprising:
a captured image acquisition unit that acquires captured images captured by an image capturing device attached to each of a plurality of moving bodies;
a selection unit that refers to limitation information to select a captured image that is to be presented from the captured images acquired by the captured image acquisition unit; and
a display unit that displays the captured image selected by the selection unit.

2. The mobile display device according to claim 1, further comprising:
an image capturing unit; and
a limitation information generation unit that refers to a captured image captured by the image capturing unit to generate the limitation information.

3. The mobile display device according to claim 1, further comprising:
a position information acquisition unit that acquires position information of a moving body attached with the image capturing device that has captured the captured image displayed by the display unit.

4. The mobile display device according to claim 3, further comprising:
a relative position calculation unit that refers to first position information that is the position information acquired by the position information acquisition unit and second position information that is the position information indicating a position of the mobile display device to calculate a relative position between the position indicated by the first position information and the position indicated by the second position information.

5. The mobile display device according to claim 1, wherein the moving body is a person or an animal.

6. An image supply device comprising:
a captured image acquisition unit that acquires captured images captured by an image capturing device attached to each of a plurality of moving bodies;
a selection unit that refers to limitation information to select a captured image that is to be presented from the captured images acquired by the captured image acquisition unit; and
an image supply unit that supplies the captured image selected by the selection unit to a mobile display device.

7. The image supply device according to claim 6, further comprising:
a limitation information acquisition unit that acquires the limitation information.

8. The image supply device according to claim 6, further comprising:
a position information acquisition unit that acquires position information of a moving body attached with the image capturing device that has captured the captured image selected by the selection unit.

9. The image supply device according to claim 8, further comprising:
a relative position calculation unit that refers to first position information that is the position information acquired by the position information acquisition unit and second position information that is the position information indicating a position of the mobile display device to calculate a relative position between the position indicated by the first position information and the position indicated by the second position information.

10. The image supply device according to claim 6, wherein the moving body is a person or an animal.

11. A display system comprising:
an image capturing device attached to each of a plurality of moving bodies;
an image supply device; and
a mobile display device, wherein
the image supply device includes
a captured image acquisition unit that acquires captured images captured by the image capturing device,
a selection unit that refers to limitation information to select a captured image that is to be presented from the captured images acquired by the captured image acquisition unit, and
an image supply unit that supplies the captured image selected by the selection unit to the mobile display device, and
the mobile display device includes
a captured image acquisition unit that acquires the captured image selected by the selection unit, and
a display unit that displays the captured image acquired by the captured image acquisition unit.

12. A program for causing a computer to function as the mobile display device according to claim 1, the program being for causing the computer to function as the selection unit.

13. A program for causing a computer to function as the image supply device according to claim 6, the program being for causing the computer to function as the selection unit.
